(19) United States
(12) Patent Application Publication
(10) Pub. No.: US 2026/0135504 A1
(43) Pub. Date: May 14, 2026

(54) MOTOR DRIVING SYSTEM AND METHOD OF CONTROLLING SAME

(71) Applicants: HYUNDAI MOTOR COMPANY, SEOUL (KR); KIA CORPORATION, SEOUL (KR)

(72) Inventors: Joon Ha Hwang, Hwaseong-si (KR); Hee Won An, Hwaseong-si (KR); Seong Min Kim, Hwaseong-si (KR); Ho Sun Jang, Hwaseong-si (KR)

(73) Assignees: HYUNDAI MOTOR COMPANY, SEOUL (KR); KIA CORPORATION, SEOUL (KR)

(21) Appl. No.: 19/229,727

(22) Filed: Jun. 5, 2025

(30) Foreign Application Priority Data
Nov. 13, 2024 (KR) 10-2024-0160659

(51) Int. Cl. H02P 27/06; H02M 7/537; H02P 6/08; H02P 6/28; H02P 25/18

(52) U.S. Cl. CPC H02P 27/06; H02M 7/537; H02P 6/08; H02P 6/28; H02P 25/18

(57) ABSTRACT

Disclosed are a motor driving system and a method of controlling the same. The motor driving system includes a motor including a plurality of windings, a first inverter including a plurality of legs each connected to one end of each of the plurality of windings, a second inverter including a plurality of legs each connected to the other end of each of the plurality of windings, and a controller configured to control phase voltages of the motor on the basis of a current command according to a required torque of the motor and a current limit preset according to current specifications of the second inverter when a preset ultra-low speed condition is satisfied.

### CROSS REFERENCE TO RELATED APPLICATIONS

This application claims priority from Korean Patent Application No. 10-2024-0160659, filed on Nov. 13, 2024 in the Korean Intellectual Property Office, the disclosure of which is incorporated herein by reference in its entirety.

### BACKGROUND

### 1. Field

The present disclosure relates to a motor driving system capable of preventing damage to an inverter in an ultra-low-speed range and a method of controlling the same.

### 2. Description of the Related Art

Generally, a first end of each of the windings of phases included in a motor is connected to an inverter, and the other ends of the windings are connected to form a Y-connection.

When the motor is driven, a switching element in the inverter is turned on/off by pulse width modulation control and applies a line voltage to the Y-connected windings of the motor to generate alternating current, thereby generating torque.

The fuel efficiency (or power efficiency) of an eco-friendly vehicle such as an electric vehicle that uses the torque generated by such a motor as power is determined by the power conversion efficiency of the inverter-motor, and thus it is important to maximize the power conversion efficiency of the inverter and the efficiency of the motor in order to improve fuel efficiency.

The efficiency of an inverter-motor system is mainly determined by a voltage utilization rate of the inverter, and if an operating point of a vehicle, which is determined by the relationship between the motor speed and torque, is formed in a range where the voltage utilization rate is high, the fuel efficiency of the vehicle can be improved.

However, as the number of winding turns of the motor increases in order to increase the maximum torque of the motor, the range with the high voltage utilization rate becomes farther away from a low torque area, which is the main operating point of the vehicle, and thus fuel efficiency may decrease. In addition, if the main operating point is designed to be included in the range with the high voltage utilization rate from the perspective of fuel efficiency, there is a limitation on the maximum torque of the motor, which may decrease the acceleration and starting performance of the vehicle.

As motor driving technology that can improve the efficiency of the system while covering both low-power and high-power ranges with one motor is required, technology for driving a single motor in two different modes using two inverters and a mode switch has been introduced.

The matters described as the background technology above are only for the purpose of increasing understanding of the background of the present disclosure and should not be recognized as corresponding to prior art already known to those skilled in the art.

### SUMMARY

The present disclosure provides a motor driving system and a method of controlling the same that can prevent damage to an inverter in an ultra-low-speed range.

The object to be achieved in the present disclosure is not limited to the object mentioned above, and other objects not mentioned will be clearly understood by those skilled in the art to which the present disclosure belongs from the description below.

In accordance with an aspect of the present disclosure, the above and other objects can be accomplished by the provision of a motor driving system including a motor including a plurality of windings, a first inverter including a plurality of legs each connected to one end of each of the plurality of windings, a second inverter including a plurality of legs each connected to another end of each of the plurality of windings, and a controller configured to control phase voltages of the motor on the basis of a current command according to a required torque of the motor and a current limit preset according to current specifications of the second inverter when a preset ultra-low-speed condition is satisfied.

In accordance with another aspect of the present disclosure, there is provided a method of controlling a motor driving system including a motor, a plurality of windings, a first inverter including a plurality of legs each connected to one end of each of the plurality of windings, and a second inverter including a plurality of legs each connected to another end of each of the plurality of windings, the method including determining whether a preset ultra-low-speed condition is satisfied, and controlling phase voltages of the motor on the basis of a current command according to a required torque of the motor and a current limit preset according to current specifications of the second inverter when the preset ultra-low-speed condition is satisfied.

### BRIEF DESCRIPTION OF THE FIGURES

The above and other objects, features and other advantages of the present disclosure will be more clearly understood from the following detailed description taken in conjunction with the accompanying drawings, in which:

FIG. 1 is a circuit diagram of a motor driving system according to an embodiment of the present disclosure;

FIG. 2 is a diagram illustrating switching of a motor driving mode according to an embodiment of the present disclosure;

FIG. 3 is a diagram illustrating a control process of a controller according to an embodiment of the present disclosure; and

FIG. 4 is a flowchart illustrating a method of controlling the motor driving system according to an embodiment of the present disclosure.

### DETAILED DESCRIPTION

Specific structural and functional descriptions of the embodiments of the present disclosure, disclosed in the present specification or application, are merely illustrative for the purpose of explaining the embodiments according to the present disclosure, and the embodiments according to the present disclosure may be implemented in various forms and should not be construed as being limited to the embodiments described in this specification or application.

Since the embodiments according to the present disclosure can be modified in various manners and have various forms, specific embodiments will be illustrated in the drawings and described in detail in the specification or application. However, this is not intended to limit the embodiments according to the concept of the present disclosure to a specific disclosed form, and should be understood to include all changes, equivalents, and substitutes included in the spirit and technical scope of the present disclosure.

All terms including technical or scientific terms have the same meanings as generally understood by a person having ordinary skill in the art to which the present disclosure pertains unless mentioned otherwise. Generally used terms, such as terms defined in a dictionary, should be interpreted to coincide with meanings of the related art from the context. Unless differently defined in the present disclosure, such terms should not be interpreted in an ideal or excessively formal manner.

Hereinafter, embodiments disclosed in the present specification will be described in detail with reference to the attached drawings. However, identical or similar components will be assigned the same reference numeral, and redundant descriptions thereof will be omitted.

In the description of the following embodiments, the term “preset” means that the value of a parameter is predetermined when the parameter is used in a process or an algorithm. Depending on embodiments, the value of a parameter may be set when a process or an algorithm starts or may be set during a period in which the process or the algorithm is performed.

The terms “module” and “unit” or “part” used to signify components are used herein to help the understanding of the components and thus they should not be considered as having specific meanings or roles.

In the following description of the embodiments disclosed in the present specification, a detailed description of known functions and configurations incorporated herein will be omitted when it may obscure the subject matter of the present disclosure. In addition, the accompanying drawings are provided only for ease of understanding of the embodiments disclosed in the present specification, do not limit the technical spirit disclosed herein, and include all changes, equivalents and substitutes included in the spirit and scope of the present disclosure.

The terms “first” and/or “second” are used to describe various components, but such components are not limited by these terms. The terms are used to discriminate one component from another component.

When a component is “coupled” or “connected” to another component, it should be understood that a third component may be present between the two components although the component may be directly coupled or connected to the other component. When a component is “directly coupled” or “directly connected” to another component, it should be understood that no element is present between the two components.

An element described in the singular form is intended to include a plurality of elements unless the context clearly indicates otherwise.

In the present specification, it will be further understood that the term “comprise” or “include” specifies the presence of a stated feature, figure, step, operation, component, part or combination thereof, but does not preclude the presence or addition of one or more other features, figures, steps, operations, components, or combinations thereof.

In addition, a unit or a control unit included in names such as a motor control unit (MCU) and a hybrid control unit (HCU) is merely a term widely used in naming a control device that controls specific vehicle functions and does not mean a generic functional unit.

A controller may include a communication device that communicates with other controllers or sensors to control the functions of the controller, a memory that stores an operating system, logic instructions, input/output information, etc., and one or more processors that perform determination, computation, and decisions necessary to control the functions.

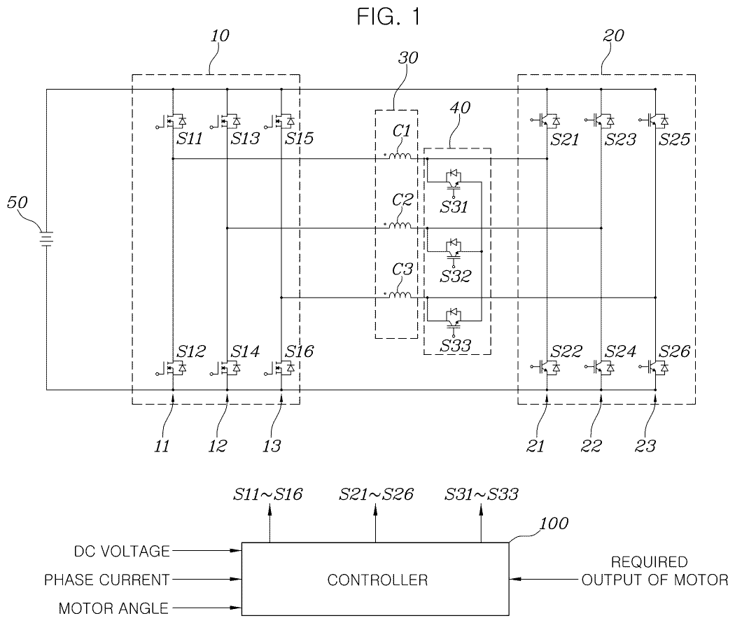

FIG. 1 is a circuit diagram of a motor driving system according to an embodiment of the present disclosure.

Referring to FIG. 1, the motor driving system according to an embodiment may include a first inverter 10, a second inverter 20, a motor 30 having a plurality of windings C1, C2, and C3 corresponding to a plurality of phases, a mode switching unit 40, a battery 50, a DC capacitor (or DC-link capacitor, 60), and a controller 70.

The first inverter 10 may include a plurality of first switching elements S11 to S16 connected to one end of each of the plurality of windings C1, C2, and C3, and the second inverter 20 may include a plurality of second switching elements S21 to S26 connected to the other end of each of the plurality of windings C1, C2, and C3. The mode switching unit 40 may include a plurality of switches S31, S32, and S33 connected between the other ends of the plurality of windings C1, C2, and C3 and the neutral terminals of the plurality of windings C1, C2, and C3. The controller 70 may control on/off states of the first switching elements S11, S12, S13, S14, S15, and S16, the second switching elements S21, S22, S23, S24, S25, and S26, and the switches S31, S32, and S33 on the basis of required output power of the motor (i.e., torque command for the motor), a DC link voltage of the inverters 10 and 20 (i.e., the voltage of the battery), the phase current of the motor, and the motor angle.

The first inverter 10 may include a plurality of legs 11, 12, and 13 to which a DC voltage generated in the DC capacitor 60 connected between both ends of the battery 50 is applied. The legs 11, 12, and 13 may be electrically connected to the plurality of phases of the motor 30.

More specifically, the first leg 11 includes two switching elements S11 and S12 connected in series between both ends of the DC capacitor 60, and the connection node of the two switching elements S11 and S12 may be connected to one end of the winding C1 of one phase in the motor 30 such that AC power corresponding to one of the plurality of phases is input and output. Similarly, the second leg 12 includes two switching elements S13 and S14 that are connected in series between both ends of the DC capacitor 60, and the connection node of the two switching elements S13 and S14 may be connected to one end of the winding C2 of one phase in the motor 30 such that AC power corresponding to one of the plurality of phases is input and output. In addition, the third leg 13 includes two switching elements S15 and S16 that are connected in series between both ends of the DC capacitor 60, and the connection node of the two switching elements S15 and S16 may be connected to one end of the winding C3 of one phase in the motor 30 such that AC power corresponding to one of the plurality of phases is input and output.

The second inverter 20 may include a plurality of legs 21, 22, and 23 to which a DC voltage generated in the DC capacitor 60 connected between both ends of the battery 50 is applied. The legs 21, 22, and 23 may be electrically connected to the plurality of phases of the motor 30.

More specifically, the first leg 21 includes two switching elements S21 and S22 connected in series between both ends of the DC capacitor 60, and the connection node of the two switching elements S21 and S22 may be connected to the other end of the winding C1 of one phase in the motor 30 such that AC power corresponding to one of the plurality of phases is input and output. Similarly, the second leg 22 includes two switching elements S23 and S24 connected in series between both ends of the DC capacitor 60, and the connection node of the two switching elements S23 and S24 may be connected to the other end of the winding C2 of one phase in the motor 30 such that AC power corresponding to one of the plurality of phases can be input and output. In addition, the third leg 23 includes two switching elements S25 and S26 connected in series between both ends of the DC capacitor 60, and the connection node of the two switching elements S25 and S26 may be connected to the other end of the winding C3 of one phase in the motor 30 such that AC power corresponding to one of the plurality of phases can be input and output.

Each of the plurality of switches S31, S32, and S33 may be connected to the other end of each of the plurality of windings C1, C2, and C3 included in the motor 30, and the other ends of the switches S31, S32, and S33 may be interconnected to form a node. The plurality of switches S31, S32, and S33 may employ various switching means known in the art, such as a MOSFET, an IGBT, a thyristor, a relay, and the like.

Although not shown in FIG. 1, the motor driving system may further include a so-called Y-capacitor (Y-Cap) that connects two capacitors connected in series between a positive (+) DC terminal and a negative (−) DC terminal and grounds the connection node between the capacitors.

The controller 70 may control operation of the motor 30 by switching the switching elements S11, S12, S13, S14, S15, S16, S21, S22, S23, S24, S25, and S26 included in the first inverter 10 and the second inverter 20 through pulse width modulation control on the basis of the required output power of the motor 30.

In addition, the controller 70 may control on/off states of the switches S31, S32, and S33 included in the mode switching unit 40 according to a motor driving mode. The motor driving mode may include a first driving mode and a second driving mode. Here, the first driving mode may be referred to as a “closed end winding (CEW) mode” and the second driving mode may be referred to as an “open end winding (OEW) mode”.

More specifically, the controller 70 may control the switches S31, S32, and S33 to be turned on and drive the motor 30 through the first inverter 10 between the two inverters 10 and 20 in the CEW mode. The mode switches S31, S32, and S33 may form a neutral point of the motor through the node to which the other ends thereof are connected in the on state.

On the other hand, the controller 70 may control the switches S31, S32, and S33 to be turned off and drive the motor 30 through the two inverters 10 and 20 in the OEW mode. The switches S31, S32, and S33 may electrically separate the node to which the other ends thereof are connected from the other ends of the plurality of windings C1 to C3 in the OFF state, and in this case, the node to which the other ends of the switches S31, S32, and S33 are connected does not form the neutral point of the motor.

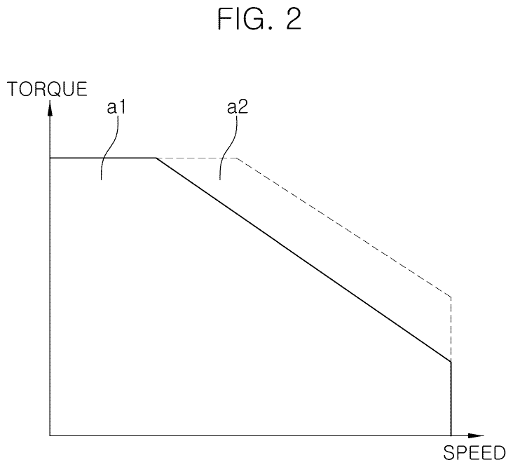

Hereinafter, driving mode switching of the motor according to an embodiment will be described with reference to FIG. 2.

FIG. 2 is a diagram illustrating switching of the motor driving mode according to an embodiment of the present disclosure.

Referring to FIG. 2, a first operating point area a1 and a second operating point area a2 are illustrated in the graph of torque and speed.

The first operating point area a1 is an operating point area corresponding to the first driving mode, and when the current target operating point of the motor 30 belongs to the first operating point area a1, the controller 70 operates such that the driving mode of the motor 30 switches to the first driving mode in principle.

The second operating point area a2 is an operating point area corresponding to the second driving mode, and when the current target operating point of the motor 30 belongs to the second driving point area a2, the controller 70 operates such that the driving mode of the motor 30 switches to the second driving mode.

Here, the second operating point area a2 includes an area having a torque greater than that of the first operating point area a1 given equal rotation speeds of the motor 30, and accordingly, the output power of the motor 30 can be increased in the second driving mode compared to the first driving mode.

The controller 70 may switch between the first driving mode and the second driving mode in both directions, the motor 30 can be efficiently driven through the first driving mode in a situation where high output power of the motor 30 is not required, and the output power of the motor 30 can be guaranteed through the second driving mode in a situation where high output power of the motor 30 is required.

Meanwhile, in an embodiment, in order to prevent inverter damage in an ultra-low-speed range, the phase voltage of the motor 30 may be controlled on the basis of a current command according to a required torque of the motor 30 and a current limit set based on the current specifications of the second inverter 20.

Here, the ultra-low-speed range means a range in which preset ultra-low-speed conditions are satisfied, and the ultra-low-speed conditions may be satisfied, for example, in a case where the operation of the motor 30 is controlled on the basis of a compensated torque command obtained by compensating for a torque command according to the required torque of the motor 31 on the basis of the electric frequency and rotor position of the motor 30 when the rotation speed of the motor 30 is equal to or lower than a preset reference speed.

In such an ultra-low-speed range, if a torque equal to or greater than a certain magnitude is applied, the current and temperature of the second inverter 20 may increase, and thus the second inverter 20 is prevented from being damaged through current limitation.

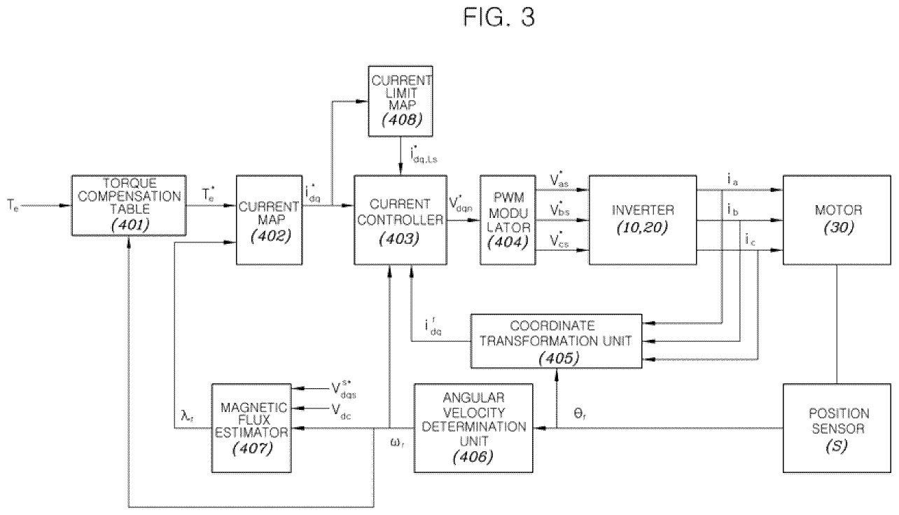

Hereinafter, a control process according to an embodiment will be described in more detail with reference to FIG. 3.

FIG. 3 is a diagram illustrating a control process of the controller according to an embodiment of the present disclosure.

Referring to FIG. 3, the controller 70 according to an embodiment may include a torque compensation table 401, a current map 402, a current controller 403, a PWM modulator 404, a coordinate transformation unit 405, an angular velocity determination unit 406, and a magnetic flux estimator 407.

First, the torque compensation table receives a required torque Tₑ and the angular velocity ωᵣ of the rotor of the motor and generates a torque command Tₑ*, and the current map 402 outputs a current command i_{dq}* of the d-q axis on the basis of the torque command Tₑ* and a magnetic flux λᵣ.

The current controller 403 generates a voltage command V_{dqn}* on the basis of the current command i_{dq}* of the d-q axis, the rotor angular velocity ωᵣ, and a d-q axis current detection value i_{dq}^{r}, and the PWM modulator 404 controls the output voltage of at least one of the first inverter 10 and the second inverter 20 through pulse width modulation based on the generated voltage command V_{dqn}*.

Through such control, phase currents iₐ, i_{b}, and i_{c} flow through the windings L1, L2, and L3 of the motor 30. The phase currents iₐ, i_{b}, and i_{c} are sensed through a current sensor connected to the motor 30, subjected to coordinate transformation in the coordinate transformation unit 405, and input to the current controller 403 in the form of d-q axis current.

Meanwhile, the motor 30 may be equipped with a position sensor S that detects the position θᵣ of the rotor, and the angular velocity determination unit 406 determines the rotor angular velocity ωᵣ on the basis of the rotor position θᵣ obtained through the position sensor S and provides the same to the torque compensation table 401, the current controller 403, and the magnetic flux estimator 407.

The magnetic flux estimator 407 determines the magnetic flux λᵣ on the basis of the rotor angular velocity ωᵣ, the voltage of the DC terminals D1 and D2, and a d-q axis target voltage and provides the same to the current map 402.

In an embodiment, the controller 70 may control the phase voltages Vₐₛ*, V_{bs}*, and V_{cs}* of the motor 30 on the basis of the current command i_{dq}* according to the required torque of the motor 30 in the ultra-low-speed range and a current limit i_{dq,Ls}* set in advance on the basis of the current specification of the second inverter 20. In this embodiment, the current limit i_{dq,Ls}* may be set in advance on the basis of the current specifications of each of the switching elements s21 to s26 connected to the plurality of legs included in the second inverter 20.

In order to control the phase voltages Vₐₛ*, V_{bs}*, and V_{cs}* of the motor 30 on the basis of current limit i_{dq,Ls}*, the controller 70 may determine the value of the current i_{dq,Ls}* with reference to a current limit map 408 in which values of the current limit i_{dq,Ls}* according to the required torque and the rotation speed of the motor are stored in advance.

The current limit map 408 may be set to output a smaller value between the current command i_{dq}* and the current limit i_{dq,Ls}* by comparing the current command i_{dq}* and the current limit i_{dq,Ls}*, and accordingly, the phase voltages Vₐₛ*, V_{bs}*, and V_{cs}* of the motor 30 can be controlled on the basis of the current command i_{dq}* when the current command i_{dq}* has a value less than the current limit i_{dq,Ls}* and can be controlled on the basis of the current limit i_{dq,Ls}* when the current command i_{dq}* has a value equal to or greater than the current limit i_{dq,Ls}*.

Therefore, a current command exceeding the current limit i_{dq,Ls}* set in consideration of the current specifications of the second inverter 20 is not applied in any case, and thus damage to the second inverter 20 can be prevented in the ultra-low-speed range.

Such current limiting can be applied when the motor 30 is driven in the OEW mode, i.e., when the second inverter 20 intervenes in driving of the motor 30.

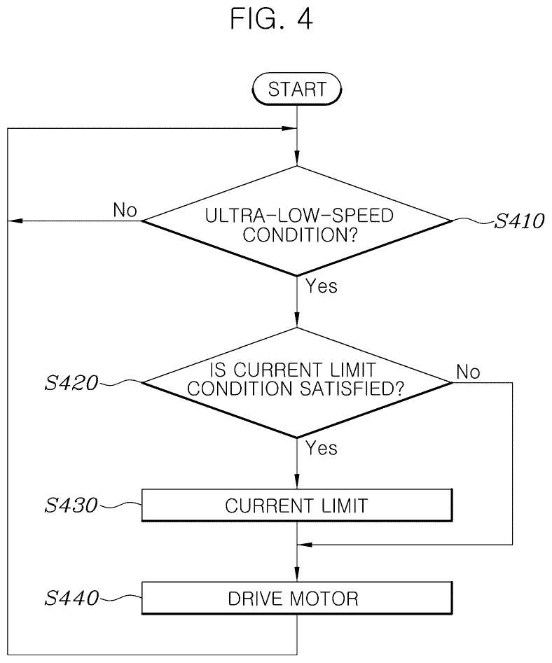

Hereinafter, a method of controlling the motor driving system according to an embodiment of the present disclosure will be described with reference to FIG. 4.

FIG. 4 is a flowchart illustrating a method of controlling the motor driving system according to an embodiment of the present disclosure.

Referring to FIG. 4, the controller 70 first determines whether a range in which the motor 30 is operating is an ultra-low-speed range on the basis of preset ultra-low-speed conditions (s410). If the ultra-low-speed conditions are satisfied (yes in s410), the controller 70 determines whether a current command satisfies current limit conditions, that is, whether the current command has a value less than a current limit (S420), and controls the phase voltages of the motor 30 according to the determination result to drive the motor 30 (S440).

The controller 70 may drive the motor 30 on the basis of the original current command without applying the current limit when the current command has a value less than the current limit and thus the current limit conditions are not satisfied (No in S420), and controls the operation of the motor 30 on the basis of the current command to which the current limit has been applied instead of the original current command when the current command has a value equal to or greater than the current limit and thus the current limit conditions are satisfied (Yes in S420).

According to various embodiments of the present disclosure as described above, it is possible to prevent damage to an inverter element due to increase in the current and temperature of the inverter element when a torque equal to or greater than a certain magnitude is applied in an ultra-low-speed range.

The effects that can be obtained from the present disclosure are not limited to the effects mentioned above, and other effects not mentioned will be clearly understood by those skilled in the art to which the present disclosure belongs from the description below.

Although the present disclosure has been illustrated and described with respect to specific embodiments as described above, it will be apparent to those skilled in the art that the present disclosure can be improved and changed in various manners without departing from the technical spirit of the present disclosure provided by the following claims.

1. A motor driving system including:
a motor including a plurality of windings;
a first inverter including a plurality of legs each connected to a first end of each of the plurality of windings;
a second inverter including a plurality of legs each connected to a second end of each of the plurality of windings; and
a controller configured to control phase voltages of the motor based on a current command according to a required torque of the motor and a current limit preset according to current specifications of the second inverter, based on a preset ultra-low-speed condition being satisfied.

2. The motor driving system of claim 1, wherein the controller determines that the ultra-low-speed condition is satisfied, based on a rotation speed of the motor being equal to or less than a preset reference speed.

3. The motor driving system of claim 1, wherein the controller determines that the ultra-low-speed condition is satisfied, based on driving of the motor being controlled by a compensated torque command obtained by compensating for a torque command according to the required torque of the motor based on an electric frequency and a rotor position of the motor.

4. The motor driving system of claim 1, wherein the current limit is preset based on current specifications of each switching element connected to each of the plurality of legs included in the second inverter.

5. The motor driving system of claim 4, wherein the controller determines a value of the current limit by referring to a current limit map in which current limits according to the required torque and rotation speed of the motor are stored in advance.

6. The motor driving system of claim 1, wherein the controller controls the phase voltages based on the current limit, based on a value of the current command exceeding the current limit.

7. The motor driving system of claim 1, wherein the controller controls the phase voltages based on the current command, based on a value of the current command being less than the current limit.

8. The motor driving system of claim 1, wherein the controller controls the phase voltages based on the current command, based on the ultra-low-speed condition being not satisfied.

9. The motor driving system of claim 1, further including a plurality of switches, one end of each of the switches being connected to the other end of each of the plurality of windings, other ends of the switches being interconnected to form a node,
wherein the controller controls a driving mode of the motor to switch to a first driving mode in which the motor is driven only using the first inverter or a second driving mode in which the motor is driven using the first inverter and the second inverter by turning on/off the plurality of switches.

10. The motor driving system of claim 9, wherein the controller controls the phase voltages of the motor based on the current command and the current limit, based on the ultra-low-speed condition being satisfied while the driving mode of the motor is the second driving mode.

11. A method of controlling a motor driving system including a motor including a plurality of windings, a first inverter including a plurality of legs each connected to a first end of each of the plurality of windings, and a second inverter including a plurality of legs each connected to another end of each of the plurality of windings, the method including;
determining whether a preset ultra-low-speed condition is satisfied; and
controlling phase voltages of the motor based on a current command according to a required torque of the motor and a current limit preset according to current specifications of the second inverter, based on the preset ultra-low-speed condition being satisfied.

12. The method of claim 11, wherein the determining includes determining that the ultra-low-speed condition is satisfied, based on a rotation speed of the motor being equal to or less than a preset reference speed.

13. The method of claim 11, wherein the determining includes determining that the ultra-low-speed condition is satisfied, based on driving of the motor is controlled by a compensated torque command obtained by compensating for a torque command according to the required torque of the motor based on an electric frequency and a rotor position of the motor.

14. The method of claim 11, wherein the current limit is preset based on current specifications of each switching element connected to each of the plurality of legs included in the second inverter.

15. The method of claim 14, further including determining a value of the current limit by referring to a current limit map in which current limits according to the required torque and rotation speed of the motor are stored in advance.

16. The method of claim 11, wherein the controlling includes controlling the phase voltages based on the current limit, based on a value of the current command exceeding the current limit.

17. The method of claim 11, wherein the controlling includes controlling the phase voltages based on the current command, based on a value of the current command being less than the current limit.

18. The method of claim 11, wherein the controlling includes controlling the phase voltages based on the current command, based on the ultra-low-speed condition being not satisfied.

19. The method of claim 11, wherein the motor driving system further includes a plurality of switches, one end of each of the switches being connected to the other end of each of the plurality of windings, other ends of the switches being interconnected to form a node,
the method further including controlling a driving mode of the motor to switch to a first driving mode in which the motor is driven only using the first inverter or a second driving mode in which the motor is driven using the first inverter and the second inverter by turning on/off the plurality of switches.

20. The method of claim 19, wherein the controlling includes controlling the phase voltages of the motor based on the current command and the current limit, based on the ultra-low-speed condition being satisfied while the driving mode of the motor is the second driving mode.
